(19) United States
(12) Patent Application Publication
(10) Pub. No.: US 2023/0274054 A1
(43) Pub. Date: Aug. 31, 2023

(54) DEGRADATION MODELLING OF UNDERGROUND VOLUME

(71) Applicant: R.H. BORDEN AND COMPANY, LLC, South Jordan, UT (US)

(72) Inventor: Jonathan R. Borden, Holladay, UT (US)

(21) Appl. No.: 17/681,157

(22) Filed: Feb. 25, 2022

(51) Int. Cl. G06F 30/27

(52) U.S. Cl. CPC G06F 30/27

(57) ABSTRACT

The computerized creation and visualization of a model of degradation of an inside surface of an underground volume. The underground volume is digitally modelled by digitally modelling an inside surface of the underground volume. The computing system performs degradation analysis of the inside surface of the underground volume by comparison of the digital model of the inside surface of the underground volume with a digital model of a reference inside surface of the underground volume. The computing system then causes to be visualized a result of the degradation analysis by causing to be displayed a visualization of the digital model of the degradation with respect to the inside surface of the underground volume.

### BACKGROUND

Underground volumes (such as conduits, pipes, tanks, and the like) are utilized to convey or store material so as to be out of the way of above-ground activities and views. For example, municipalities typically have a network of underground utilities which provide service to their residents, businesses, and other entities within the boundaries of the municipality. Some of those utilities include underground facilities for conveying wastewater, such as rain runoff or household liquid waste (collectively referred to hereinafter as “wastewater”). Municipalities, companies, and even private landowners also may own underground volumes in the form of tanks or pipes.

Accordingly, underground wastewater utilities typically have a number of “manholes”, referred to as such because they are large enough for a person to descend through (after removing the protective manhole cover) to perform inspections or repairs on the underground volume. The manhole is typically in the form of a vertical shaft that connects the underground volume to a ground-level surface, such as at a street. Such underground volumes are often not intended to be easily accessed, lest unqualified individuals dangerously enter therein. For this and other reasons, the manholes are typically protected by a heavy manhole cover. Inspection of a manhole is thus not a trivial task.

Manhole degradation can occur over time, due to such environmental factors as corrosion, vibrations, thermal stresses, earth movement, chemical reactions, and so forth. Such degradation can impact the safety and functionality of the underground volume, potentially resulting in service interruptions, or even leaking between the underground volume and the environment. Accordingly, underground volumes should be kept in good repair.

To evaluate status of an underground volume and potentially perform repairs, a human inspector typically physically goes to the location of the manhole, enters the manhole, observes the underground volume, and writes down notes of any observed damage and/or performs repair. Alternatively, a camera can be lowered into the manhole to take images of the manhole interior.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments described herein relate to the computerized creation and visualization of a model of degradation of an inside surface of an underground volume. As examples, the underground volume could be a manhole, a pipe, a tank or any other closed or open underground volume. Such underground volumes are difficult or perhaps even dangerous to access for inspection. Furthermore, even when accessed, it can be difficult to actually measure degradation of the inside surface (e.g., the walls) of the underground volume. Excessive degradation can cause the underground volume to fail.

In accordance with the principles described herein, the underground volume is digitally modelled by digitally modelling an inside surface of the underground volume. The computing system performs degradation analysis of the inside surface of the underground volume by comparison of the digital model of the inside surface of the underground volume with a digital model of a reference inside surface of the underground volume. The computing system then causes to be visualized a result of the degradation analysis by causing to be displayed a visualization of the digital model of the degradation with respect to the inside surface of the underground volume.

Thus, visualization of the degradation analysis may be viewed by a human user at any time and from any place. This may be performed for numerous underground volumes allowing the user to virtually inspect many underground volumes at their convenience, comfort, and safety. For instance, the user may be presented with a digital map, and may select any of the underground volumes from the digital map and see the results of the degradation analysis and/or a visualization of a model of the degradation at will. This is particularly advantageous as manual inspection of underground volumes can be difficult, unsafe, and perhaps even impossible for the user to perform. Entry into some confined spaces (such as manholes) can even be dangerous or fatal due to the gasses and other confined space hazards.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 abstractly illustrates an environment in which the principles described herein may be practiced, which includes a ground-level and an underground volume that is to have its degradation digitally modelled, in accordance with the principles described herein;

FIG. 2 illustrates a flowchart of a computer-performed method for creating and causing to be visualized a model of degradation of an inside surface of an underground volume, in accordance with the principles described herein;

FIG. 3 illustrates a digital model of the inside surface of an underground volume that takes the form of a manhole;

FIG. 4 illustrates a more detailed view of a visualization of a degradation model superimposed upon a digital model of the inside surface of a manhole;

FIG. 5 is illustrated a digital map that illustrates markers for multiple underground volumes;

FIG. 6 illustrates a flowchart of a method for using a digital map populated by the visualizations of the underground volumes;

FIG. 7 illustrates a more detailed digital map that includes a map frame that illustrates various streets and underground volume locations, and a control frame for controlling what is viewed within the map frame; and

FIG. 8 illustrates an example computing system in which the principles described herein may be employed.

### DETAILED DESCRIPTION

Embodiments described herein relate to the computerized creation and visualization of a model of degradation of an inside surface of an underground volume. As examples, the underground volume could be a manhole, a pipe, a tank or any other closed or open underground volume. Such underground volumes are difficult or perhaps even dangerous to access for inspection. Furthermore, even when accessed, it can be difficult to actually measure degradation of the inside surface (e.g., the walls) of the underground volume. Excessive degradation can cause the underground volume to fail.

In accordance with the principles described herein, the underground volume is digitally modelled by digitally modelling an inside surface of the underground volume. The computing system performs degradation analysis of the inside surface of the underground volume by comparison of the digital model of the inside surface of the underground volume with a digital model of a reference inside surface of the underground volume. The computing system then causes to be visualized a result of the degradation analysis by causing to be displayed a visualization of the digital model of the degradation with respect to the inside surface of the underground volume.

Thus, visualization of the degradation analysis may be viewed by a human user at any time and from any place. This may be performed for numerous underground volumes allowing the user to virtually inspect many underground volumes at their convenience, comfort, and safety. For instance, the user may be presented with a digital map, and may select any of the underground volumes from the digital map and see the results of the degradation analysis and/or a visualization of a model of the degradation at will. This is particularly advantageous as manual inspection of underground volumes can be difficult, unsafe and perhaps even impossible for the user to perform. Entry into some confined spaces (such as manholes) can even be dangerous or fatal due to the gasses and other confined space hazards.

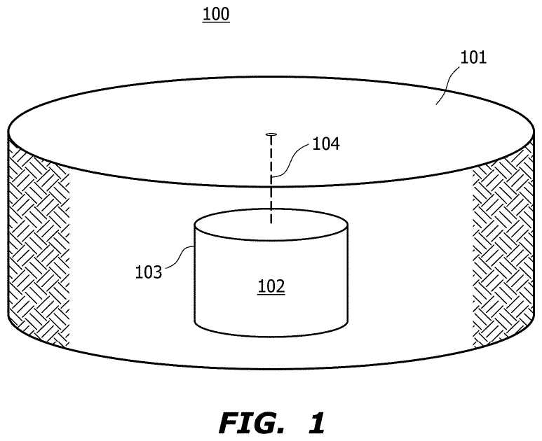

FIG. 1 abstractly illustrates an environment 100 in which the principles described herein may be practiced. The environment 100 includes a ground-level 101 and an underground volume 102. The principles described herein are not limited to the nature of the underground volume 102. The underground volume 102 may be any shape suitable for its purpose, but is illustrated as a cylinder merely for example purposes only.

The underground volume 102 may be a closed volume, such as for example a tank. Alternatively, the underground volume 102 may be an open volume such as for example a manhole, viaduct, pipe, or combinations thereof. The underground volume 102 has a wall 103 that defines the underground volume 102, and that acts as a barrier keeping material (e.g., earth) outside of the wall from entering the underground volume, and keeping material (e.g., water, solids and/or gases) contained within the underground volume from entering into the surrounding environment. The wall 103 is subject to degradation over time, such as by kinetic activity (such as earth movement or erosion), chemical reactions (such as corrosion, oxidation, or buildup), or structural problems (such as line delamination). To allow inspection or repair of the underground volume 102, there may be a way to access the underground volume 102 by a person or sensor. This access is represented by the dashed line 104.

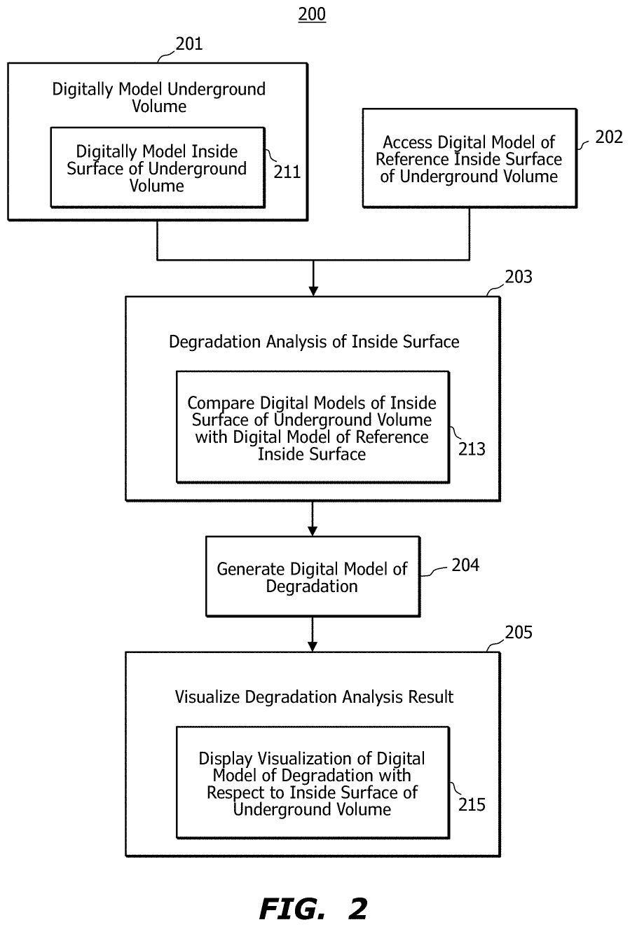

FIG. 2 illustrates a flowchart of a computer-performed method 200 for creating and causing to be visualized a model of degradation of an inside surface of an underground volume, in accordance with the principles described herein. As an example, the method 200 may be used to create and visualize a model of degradation of the inside surface of the wall 103 of the underground volume 102 of FIG. 1. Accordingly, the method 200 of FIG. 2 and subsequent figures will hereinafter be sometimes described with reference to the underground volume 102 of FIG. 1.

The method 200 includes digitally modelling an underground volume (act 201). This digital model is a three-dimensional representation of the underground volume. The digital modeling is performed by digitally modelling an inside surface of the underground volume (act 211). As an example only, a tool may be lowered into the underground volume 102 (e.g., via the access 104) to take a three-dimensional topographical scan of at least a portion of the inside surface of the wall 103 of the underground volume 102. Thus, the digital model created in act 201 models the inside surface of the underground volume as that underground surface exists including degradations.

In addition, a digital model of a reference inside surface of the underground volume is accessed (act 202). This digital model of the reference inside surface represents a three-dimensional model of an example un-degraded shape of the inside surface of the underground volume. For instance, perhaps the digital model of the reference inside surface is a predetermined shape selected from a library of shapes. Alternatively, perhaps the digital model of the reference inside surface is a digital model of the inside surface as that inside surface existed immediately after the underground volume was installed. Alternatively, perhaps the digital model of the reference inside surface models an initial design of the underground volume.

This digital model of the inside surface of the underground volume is then used to perform degradation analysis of the inside surface of the underground volume (act 203). This is done by comparing the digital model of the inside surface of the underground volume with the digital model of a reference inside surface of the underground volume (act 213).

This degradation analysis results in a digital model of the degradation of the inside surface of the underground volume (act 204). Thereafter, the result of the degradation analysis can be visualized to a user (act 205). Specifically, this may be accomplished by causing to be displayed the visualization of the digital model of the degradation with respect to the inside surface of the underground volume (act 215).

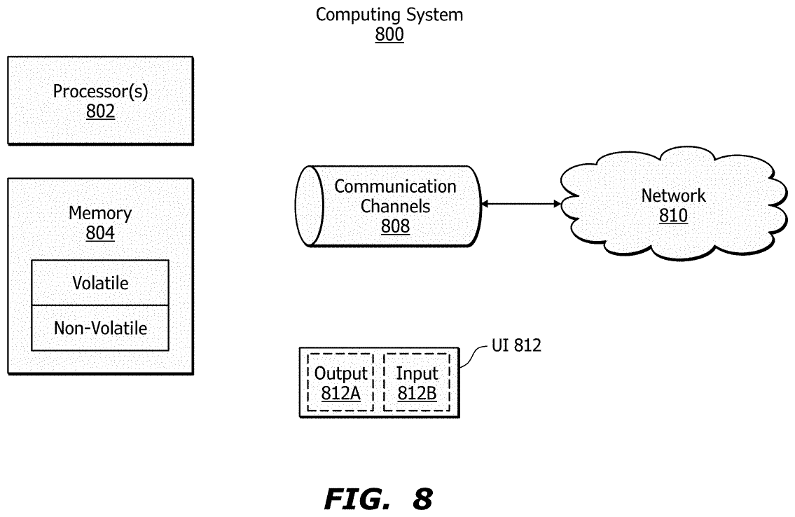

The method 200 may be performed by a computing system, such as the computing system 800 described below with respect to FIG. 8. Thus, visualization of the degradation analysis may be viewed by a human user at any time and from any place so long as the user has access to visualizations produced by the computing system 800. As an example, the user may be sitting in a comfortable space in front of a computing system, and review the degradation of the underground volume from their comfortable and safe space above the ground, such as within the user's office or home.

Furthermore, the visualization is of the degradation model with respect to the inside surface of the underground volume. Such a degradation model can be made to give a much clearer view of the degradation than could the naked eye. Thus, the user may actually get a better idea of the degradation from their comfortable and safe space than they could if they were to physically enter and observe the inside surface of the underground volume with their bare eyes.

From a comfortable and safe place, the user may additionally use a virtual reality device (such as a headset) that allows the user to virtually enter the underground volume and make observations of the digital model of the degradation with respect to the digital model of the inside surface of the underground volume. For instance, the digital model of the degradation may be a colorized pattern that shows different colors depending on the degree that degradation has caused material to be eliminated from or added to the inside surface of the underground volume, or has caused material to be displaced (such as by delamination of a liner).

In one example implementation, the underground volume 102 is a manhole. Furthermore, the inside surface of the underground volume 102 is modeled by using a point-cloud generated from sensor measurements, where each point represents a position on the inside surface of the underground volume. A digital model of the surface may then be created by forming triangles between each set of three proximate points in the point cloud.

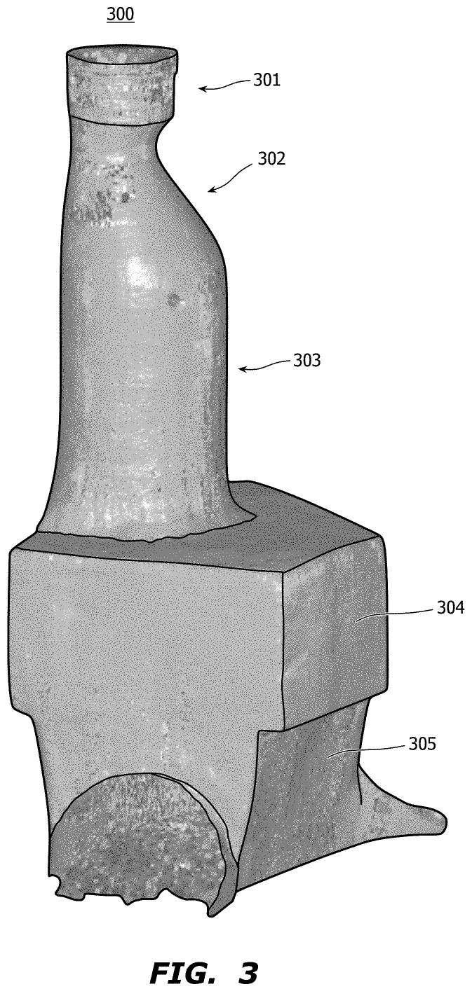

FIG. 3, for example, illustrates a digital model 300 of the inside surface of an underground volume, which takes the form of a manhole. The digital model 300 is an example of the digital model created in act 201 of FIG. 2. Such a manhole typically allows a person to enter and descend vertically downward (with a ladder) to approach a horizontal channel of a network (such as a wastewater network). This digital model 300 was generated using a point cloud that includes points positioned so as to represent a position of an associated point on the inside surface of the manhole. The modelled manhole includes the manhole chimney 301, the cone section 302, the barrel section 303, a bench section 304, and portions of a channel section 305. Note that there are smoother sections of the manhole, and rougher sections of the manhole, reflecting a good approximation of the actual condition of the inside surface of the manhole.

In this example, only a portion of the channel section 305 is modelled due to the limited reach of the sensor that generated the point cloud samples. However, the principles described herein are not limited to the geometry or identity of the underground volume, nor is it limited to which portion(s) of the underground volume are digitally modelled. The principles described herein are also not limited to the resolution or exactness of the digital model in representing the actual inside surface at a particular time. Nevertheless, the higher the fidelity of the digital model to the actual inside surface as it existed at that particular time, the more accurate the degradation model can be.

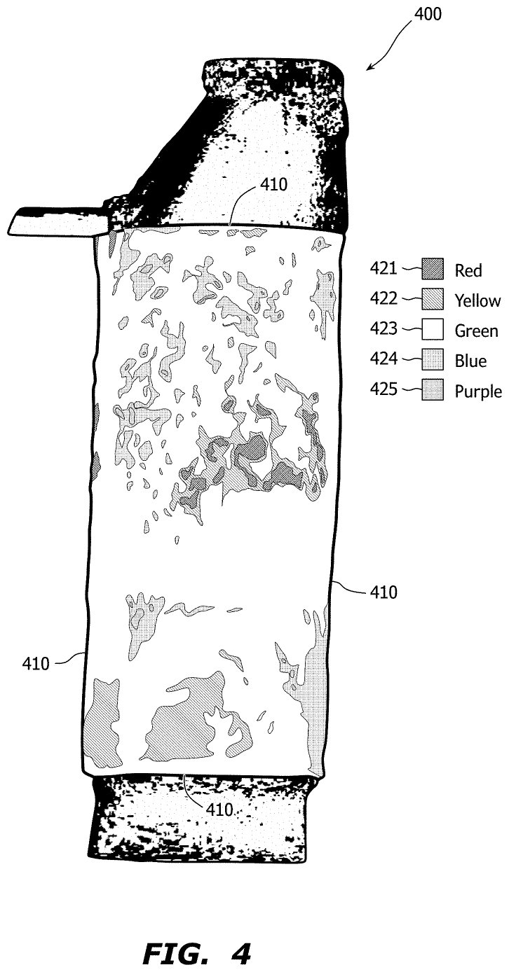

FIG. 4 illustrates a more detailed view of a visualization 400 of a degradation model 410 superimposed upon a digital model of the inside surface of a manhole. Specifically, the degradation model 410 is superimposed upon the inside surface of the barrel portion of the manhole. The degradation model 410 is an example of the degradation model generated in act 204 of FIG. 2. Furthermore FIG. 4 illustrates an example of a visualization caused to be displayed in act 205 of FIG. 2. Specifically, FIG. 4 illustrates a visualization of a digital model of degradation with respect to the inside surface of the manhole, the visualization being an example of the visualization displayed in act 215 of FIG. 2.

The degradation model is a three-dimensional model of depths of removal/addition of material due to degradation. In the case in which the digital model of the inside surface was generated from a point cloud, that same point cloud may be used as a basis for generating the degradation model. Specifically, the comparing of the digital model of the inside surface of the underground volume with a digital model of the reference inside surface of the underground volume (act 213) could include measuring distances between points in the point cloud with the reference inside surface of the underground volume. Thus, each point in the point cloud could have an associated spatial difference, representing a depth of degradation at that point. The surface of the triangle of three proximate points in the point cloud could then be colorized corresponding to associated spatial depths of those three proximate points.

The visualization of the degradation model 410 shown in FIG. 4 uses colors to represent depth of removal, addition and/or displacement of material due to degradation In FIG. 4, those colors are represented by fill patterns as represented by legend 420. In the example of FIG. 4, areas of significant removal are represented by the cross-hatched fill pattern 421 (which would be red in color). Areas of moderate removal are represented by a right-hatched fill pattern 422 (which would be yellow in color). Areas of no significant degradation are represented by a no fill pattern 423 (which would be green in color). Areas of moderate addition (e.g., caused by material being added or displacement of material such as a liner) are represented by a light dotted fill pattern (which would be blue in color). Areas of heavy addition are represented by a dense dotted fill pattern 425. Where the diagrams are limited by black and white, it is helpful to show colors as discrete in number (five fill patterns in FIG. 4). However, on a computing system, the degradation removal and addition may be represented more as a gradient of colors ranging from deep red to deep purple, allowing for more information about the depth of the removal or addition to be conveyed.

To supplement the digital model, a degradation score may also be generated to represent degradation of the inside surface of the underground volume as a single score. This score could be, for instance, some statistic (e.g., standard deviation) of the spatial differences between the points in the point cloud of the inside surface of the underground volume and the corresponding positions of the reference inside surface. The degradation score may also be generated by applying the degradation measures to a machine learning model that predicts the state of degradation.

As previously mentioned, the causing to be displayed a visualization of the digital model of the degradation with respect to the inside surface of the underground volume (act 215) may be performed by visualizing the degradation model superimposed upon another digital model of the inside surface of the underground volume. That digital model of the inside surface could be the digital model generated in act 201. In this case, the visualization could be viewed using a computing system or a virtual reality device. Furthermore, although FIG. 4 illustrates the visualization as viewed from the outside of the manhole, a virtual reality device would allow the user to view the visualization from a virtual position inside of the manhole.

In an alternative, the causing to be displayed a visualization of the digital model of the degradation with respect to the inside surface of the underground volume (act 215) may be performed by visualizing the degradation model superimposed upon a digital model of the reference inside surface of the underground volume. Such may be helpful if focus is to be on the degradation model, rather than on a visualization of the actual degradation.

As another alternative, the user may indeed enter into the underground volume, and the degradation model may then be visually superimposed upon the actual inside surface itself. Thus, in this case, the causing to be displayed a visualization of the digital model of the degradation with respect to the inside surface of the underground volume (act 215) may be performed by visualizing the degradation model superimposed upon the actual inside surface of the underground volume, rather than superimposed upon a digital model. Thus, a mixed reality device may be used to supplement the senses of an inspector that physically enters an underground volume. After all, even an experienced inspector may not get a perfectly correct sense of the amount of degradation on a wall of an underground volume. That underground inspector may have limited lighting, may not have a correct sense of where the level of the wall originally was, or may estimate incorrectly the depths associated with removal or addition of material.

As previously described, degradation analysis may be performed by comparing a digital model of the inside surface of the underground volume with a digital model of a reference inside surface of the underground volume. Such would give an accurate view of degradation as it exists at a particular point in time. However, the principles described herein may allow a view on how fast degradation is occurring. This may be accomplished by generating multiple digital models of the inside surface of the underground volume, each representing a state of the inside surface at different points in time. This allows a view on how fast degradation is occurring.

For example, act 201 may occur multiple times at different times. There may thus be a first digital model of the inside surface as the inside surface existed at a first time, a second digital model of the inside surface as the inside surface existed at a second time, and so forth for potential additional digital models of the inside surface as it existed at other times. In this case, the degradation analysis may alternatively or additionally comprise generation of a degradation velocity measure at multiple points in the inside surface. That may be used to determine a rate of degradation at each surface area, allowing for that degradation rate to be visualized as well. The rate of degradation may be quite important to determine when the underground volume may fail, and thus how urgent repairs are.

To supplement the digital model, a degradation velocity score may also be generated to represent a rate of degradation of the inside surface as a single score. This score could be, for instance, some statistic (e.g., standard deviation) of the rate of degradation between the points in the point cloud of the inside surface and the corresponding positions of the reference inside surface. A degradation urgency score could also be calculated that is a function of both the static degradation score and the degradation velocity score. After all, degradations that are deepest and fastest may imply wall failure immanency. The degradation urgency score may also be generated by applying the degradation measures to a machine learning model that predicts an imminency of failure.

Up to this point, the generation of a visualization of degradation of a single underground volume has been described. However, the principles described herein are not limited to that, and may be performed for multiple and perhaps many underground volumes. As an example, the principles described herein may be used to digitally model degradation for most or all of the underground volumes (e.g., manholes) within a particular municipality. The principles described herein are also directed towards organizing such models of degradation.

As an example only, those models may be organized onto a digital map, allowing a user to select a particular underground volume for a virtual inspection and/or perhaps to view more information about the degradation of that underground volume. A priority of the underground volume may also be rendered that shows which underground volume have most urgent repairs. Thus, the principles described herein are a powerful tool for owners of many underground volumes (such as municipalities or large land owners) to prioritize and schedule repair.

A municipality is not always fully aware of the condition of their underground volumes (e.g., manholes), especially where the resources available for inspecting manholes does not match well with the number of manholes within the municipality. Even where there are sufficient numbers of human inspectors available to inspect each manhole at a suitable frequency, such human inspectors make subjective judgments about the state of the manhole, as well as whether repairs are recommended. Accordingly, it can be difficult for the municipality to know which manholes have suffered the most degradation and need to be prioritized for repair.

In one embodiment, the digital model of an underground volume includes a representation of a geographic location of the underground volume. A visualized representation of the underground volume is then represented on a digital map. The position of the visualization in the digital map corresponds to the geographic location of the underground volume. The visualized representation of the underground volume on the digital map can also represent the generated degradation score of the underground volume.

In this manner, representatives of the municipality can see a digital map of the geographic locations of manhole(s) that exist within the municipality. The visualized representations of the manholes can be visually emphasized based on the degradation score of each of the manholes. Thus, the municipality can more easily prioritize which manholes are in most need of repair based on the degradation scores for the manholes or based on the visual emphasis of the visualized representations of the manholes on the digital map. In some embodiments, a user can select the visualized representation of a underground volume on the digital map in order to see the visualization of the degradation model with respect to the inside surface.

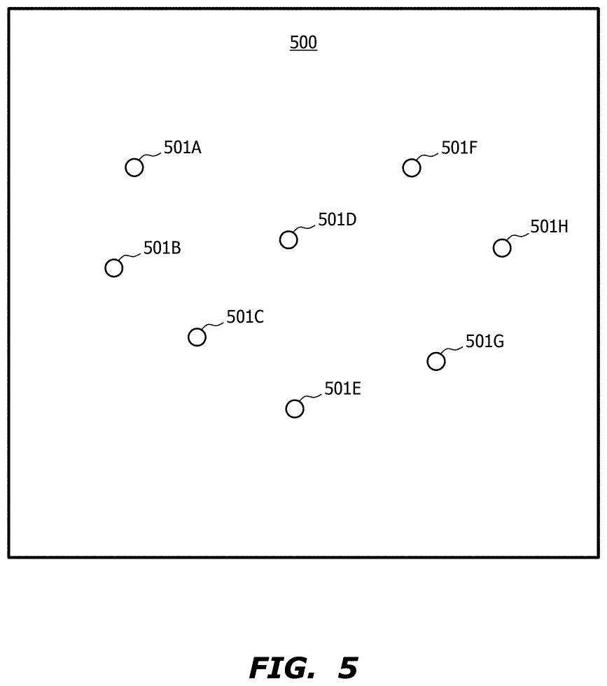

FIG. 5 abstractly illustrates a digital map 500 that has markers 501 for multiple underground volumes, each potentially including a degradation model and/or a degradation score (e.g., a static degradation score, a degradation velocity score and/or a degradation urgency score). Each marker is positioned on the digital map 500 at a position that corresponds to the geographical location of the respective underground volume.

The digital map 500 illustrates that there are 8 markers 501 including markers 501A through 501H. But this is also for example purposes only and is also kept simple for explanation purposes. The precise positioning of manholes will be a matter of the design of the municipality. In addition, the number of manholes is often quite large for larger municipalities, and can even enter into the thousands for larger municipalities. Accordingly, the principles described herein are not limited to the position or number of markers within a municipality. The markers may represent the same kind of underground volume (e.g., manholes only) or may represent a combination of types of volumes (e.g., manholes, pipes, tanks, and so forth).

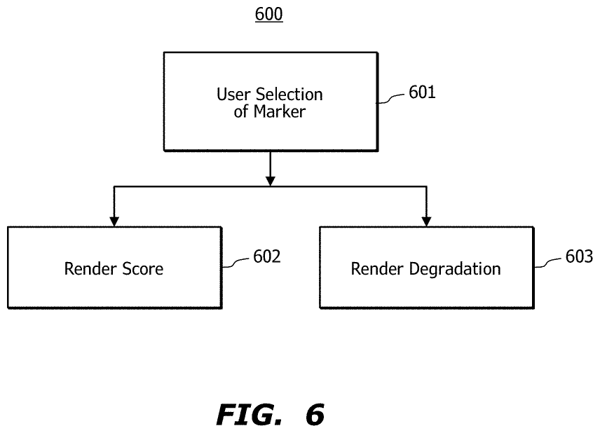

FIG. 6 illustrates a flowchart of a method 600 for using a digital map populated by the visualizations of the underground volumes. The method 600 may be performed using the digital map 500 of FIG. 5 as an example. The method 600 may be performed by a computing system such as the computing system 800 of FIG. 8.

The method 600 is initiated upon detecting a user selection (act 601) of a visual representation of a particular underground volume. As an example, the user may select one of the markers 501 from the digital map. In response, a degradation score is displayed (act 602). Alternatively, or in addition, in response to the user selection, a visualization is caused to be displayed of a degradation model with respect to the inside surface of the particular underground (act 603). Thus, the user can quickly and conveniently assess degradation of any underground volume represented in the digital map.

The markers of the digital map may be adorned to illustrate more information about the degradation of the associated underground volume. For instance, a color of the marker may represent a degradation score. Thus, for instance, a marker may be red to emphasize that degradation is severe in the associated underground volume. Other adornments may be used for particular events that have occurred with respect to the underground volume, such as the most recent time of last modelling, whether infiltration has occurred (e.g., due to failure of the wall), and so forth.

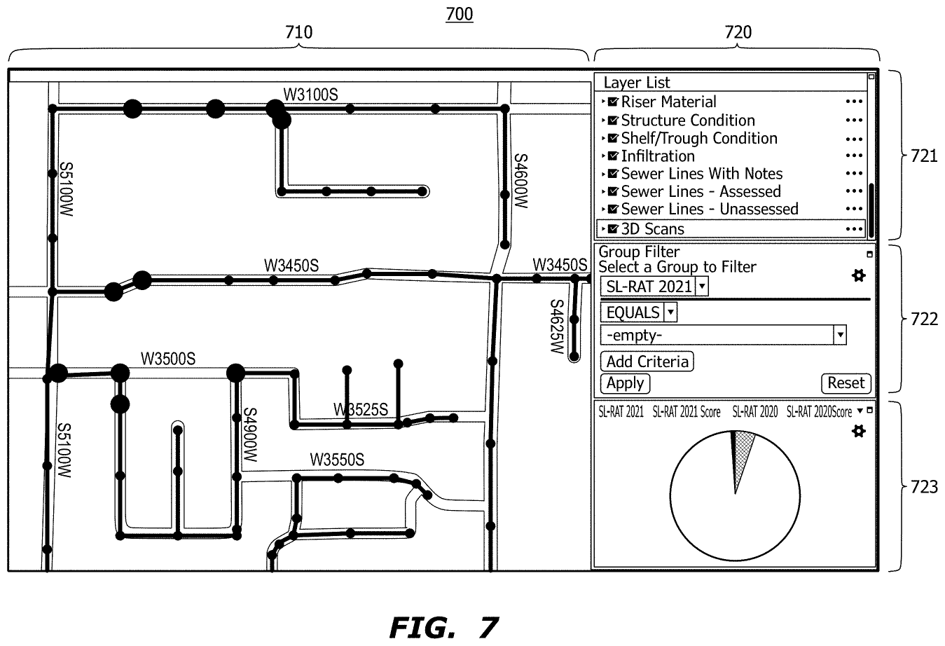

FIG. 7 illustrates a more detailed digital map 700 of one example. The digital map includes a map frame 710 that illustrates various streets and underground volume locations. A control frame 720 includes various controls and aggregated information about what is displayed in the map frame 710. For instance, the control frame 720 includes a layer list frame 721 that has various checkboxes to illustrate what underground volumes are marked in the map frame. As an example, the user could select to layer based on 1) riser material, 2) structure condition, 3) shelf/trough condition, 4) infiltration, 5), volumes with notes, 6) assessed volumes, 7) unassessed volumes, and so forth. A group filter frame 722 allows for criteria to be applied in filtering the markers that are shown. An aggregate view frame 723 shows an aggregated view (in pie chart form) of the condition of the underground volumes that are represented by markers in the map frame 710.

Thus, the principles described herein are a valuable tool in assessing degradation of underground volumes, whether assessing a single underground volume, or whether assessing numerous underground volumes. Because the principles described herein are performed in the context of a computing system, some introductory discussion of a computing system will be described with respect to FIG. 8.

Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 8, in its most basic configuration, a computing system 800 includes at least one hardware processing unit 802 and memory 804. The processing unit 802 includes a general-purpose processor. Although not required, the processing unit 802 may also include a field programmable gate array (FPGA), an application specific integrated circuit (ASIC), or any other specialized circuit. In one embodiment, the memory 804 includes a physical system memory. That physical system memory may be volatile, non-volatile, or some combination of the two. In a second embodiment, the memory is non-volatile mass storage such as physical storage media. If the computing system is distributed, the processing, memory and/or storage capability may be distributed as well.

The computing system 800 also has thereon multiple structures often referred to as an “executable component”. For instance, the memory 804 of the computing system 800 is illustrated as including executable component 806. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods (and so forth) that may be executed on the computing system. Such an executable component exists in the heap of a computing system, in computer-readable storage media, or a combination.

One of ordinary skill in the art will recognize that the structure of the executable component exists on a computer-readable medium such that, when interpreted by one or more processors of a computing system (e.g., by a processor thread), the computing system is caused to perform a function. Such structure may be computer readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within a FPGA or an ASIC, the computer-executable instructions may be hard-coded or hard-wired logic gates. The computer-executable instructions (and the manipulated data) may be stored in the memory 804 of the computing system 800. Computing system 800 may also contain communication channels 808 that allow the computing system 800 to communicate with other computing systems over, for example, network 810.

While not all computing systems require a user interface, in some embodiments, the computing system 800 includes a user interface system 812 for use in interfacing with a user. The user interface system 812 may include output mechanisms 812A as well as input mechanisms 812B. The principles described herein are not limited to the precise output mechanisms 812A or input mechanisms 812B as such will depend on the nature of the device. However, output mechanisms 812A might include, for instance, speakers, displays, tactile output, virtual or augmented reality, holograms and so forth. Examples of input mechanisms 812B might include, for instance, microphones, touchscreens, virtual or augmented reality, holograms, cameras, keyboards, mouse or other pointer input, sensors of any type, and so forth.

Embodiments described herein may comprise or utilize a special-purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmission media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RANI within a network interface module (e.g., a “NIC”), and then be eventually transferred to computing system RANI and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special-purpose computing system, or special-purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

What is claimed is:

1. A method for creating and causing to be visualized a model of degradation of an inside surface of an underground volume, the method comprising:
digitally modelling an underground volume by digitally modelling an inside surface of the underground volume;
performing degradation analysis of the inside surface of the underground volume by comparing the digital model of the inside surface of the underground volume with a digital model of a reference inside surface of the underground volume; and
causing to be visualized a result of the degradation analysis by causing to be displayed a visualization of the digital model of the degradation with respect to the inside surface of the underground volume.

2. The method in accordance with claim 1, the digital model of the inside surface of the particular underground volume being a first digital model of the inside surface of the particular underground volume as the inside surface existed at a first time, the particular underground volume also having a second digital model of the inside surface of the particular underground volume as the inside surface existed at a second time that is different than the first time,
the degradation analysis comprising a degradation velocity analysis that compares the digital model of the inside surface of the underground volume as the inside surface existed at the first time with the digital model of the inside surface of the underground volume as the inside surface existed at the second time.

3. The method in accordance with claim 1, the digital model of the inside surface of the particular underground volume being generated from a point cloud representing points associated with the inside surface of the particular underground volume.

4. The method in accordance with claim 3, the comparing of the digital model of the inside surface of the underground volume with a digital model of a reference inside surface of the underground volume comprising measuring distance between points in the point cloud with the reference inside surface of the underground volume.

5. The method in accordance with claim 1, the causing to be displayed a visualization of the digital model of the degradation with respect to the inside surface of the underground volume comprising:
causing to be visualized a result of the degradation analysis by causing to be displayed a visualization of the digital model of the degradation with respect to the digital model of the inside surface of the underground volume.

6. The method in accordance with claim 1, the causing to be displayed a visualization of the digital model of the degradation with respect to the inside surface of the underground volume comprising:
causing to be visualized a result of the degradation analysis by causing to be displayed a visualization of the digital model of the degradation with respect to the digital model of the reference inside surface of the underground volume.

7. The method in accordance with claim 1, the underground volume comprising at least a portion of a manhole, pipe or tank.

8. The method in accordance with claim 1, the underground volume being a particular underground volume, the method being further for organizing models of degradation of a plurality of underground volumes that includes the particular volume, the method comprising:
digitally representing a plurality of underground volumes in a computing system, the digital representation for at least some of the plurality shafts, including the particular underground volume, including 1) a representation of a geographic location of the underground volume, and 2) a digital model of an inside surface of the underground volume;
for at least the particular underground volume, performing the following:
generating a degradation score for the particular underground volume using the representation of the inside surface of the particular shaft; and
causing a visualized representation of the particular underground volume to be displayed on a digital map such that a position of the visualized representation of the particular underground volume corresponds to the representation of the geographic location of the particular underground volume, the visualized representation of the particular underground volume on the digital map including a visual representation of the generated degradation score for the particular shaft.

9. The method in accordance with claim 8, the digital model of the inside surface of the particular underground volume being generated from a point cloud representing points associated with the inside surface of the particular underground volume, the generating a degradation score comprising measuring spatial distances between the reference inside surface on the underground volume and respective points in the point cloud.

10. The method in accordance with claim 9, the degradation score being a result of applying a statistical calculation on the plurality of representations of spatial differences.

11. The method in accordance with claim 8, the digital model of the inside surface of the particular underground volume being generated from a point cloud representing points associated with the inside surface of the particular underground volume, the generation of the degradation score being performed by applying the point cloud as input to a machine learning model that is configured to generate degradation scores using point clouds.

12. The method in accordance with claim 8, the digital model of the inside surface of the particular underground volume being a first digital model of the inside surface of the particular underground volume as the inside surface existed at a first time, the particular underground volume also having a second digital model of the inside surface of the particular underground volume as the inside surface existed at a second time that is different than the first time.

13. The method in accordance with claim 12, the degradation score generated for the particular underground volume using the first digital model of the particular underground volume being a first degradation, the method further comprising:
generating a second degradation score for the particular underground volume using the second digital model of the inside surface of the particular underground volume.

14. The method in accordance with claim 13, further comprising:
generating a degradation velocity score using at least the first degradation score and the second degradation score.

15. The method in accordance with claim 12, wherein the degradation score is a degradation velocity score, the generating of the degradation score being performed using at least the first digital model and the second digital model of the inside surface of the particular underground volume.

16. The method in accordance with claim 8, further comprising the following:
detecting user selection of the visual representation of the particular underground volume on the digital map; and
in response to detecting the user selection, causing to be displayed the degradation score.

17. The method in accordance with claim 8, further comprising the following:
detecting user selection of the visual representation of the particular underground volume on the digital map; and
in response to detecting the user selection, performing the causing to be displayed the visualization of the digital model of the degradation with respect to the inside surface of the underground volume.

18. The method in accordance with claim 1, the causing to be displayed the visualization of the digital model of the degradation with respect to the inside surface of the underground volume being performed using virtual reality or mixed reality.

19. A computing system comprising:
one or more processors; and
one or more computer-readable media having thereon computer-executable instructions that are structured such that, if executed by the one or more processors, the computing system would be configured to create and cause to be visualized a model of degradation of an inside surface of an underground volume, by being configured to perform the following:
digitally modelling an underground volume by digitally modelling an inside surface of the underground volume;
performing degradation analysis of the inside surface of the underground volume by comparing the digital model of the inside surface of the underground volume with a digital model of a reference inside surface of the underground volume; and
causing to be visualized a result of the degradation analysis by causing to be displayed a visualization of the digital model of the degradation with respect to the inside surface of the underground volume.

20. A computer program product comprising one or more computer-readable storage media having stored thereon computer-executable instructions that are structured such that, if executed by one or more processors of a computing system, would cause the computing system to be configured to create and cause to be visualized a model of degradation of an inside surface of an underground volume, by being configured to perform the following:
digitally modelling an underground volume by digitally modelling an inside surface of the underground volume;
performing degradation analysis of the inside surface of the underground volume by comparing the digital model of the inside surface of the underground volume with a digital model of a reference inside surface of the underground volume; and
causing to be visualized a result of the degradation analysis by causing to be displayed a visualization of the digital model of the degradation with respect to the inside surface of the underground volume.
